(19) United States
(12) Patent Application Publication
(10) Pub. No.: US 2022/0103083 A1
(43) Pub. Date: Mar. 31, 2022

(54) METHOD AND SYSTEM USING A NOISE FILTER TO DRIVE SYNCHRONOUS RECTIFIERS OF AN LLC DC-DC CONVERTER

(71) Applicants: Xiang ZHOU, Kingston (CA); Wenbo LIU, Kingston (CA); Bo SHENG, Kingston (CA); Yang CHEN, Kingston (CA); Andrew YUREK, Kingston (CA); Yan-Fei LIU, Kingston (CA); Lakshmi Varaha IYER, Troy, MI (US); Gerd SCHLAGER, Kefermarkt (AT); Michael NEUDORFHOFER, Sankt Valentin (AT); Wolfgang BAECK, Sankt Valentin (AT); MAGNA INTERNATIONAL INC., Aurora (CA)

(72) Inventors: Xiang ZHOU, Kingston (CA); Wenbo LIU, Kingston (CA); Bo SHENG, Kingston (CA); Yang CHEN, Kingston (CA); Andrew YUREK, Kingston (CA); Yan-Fei LIU, Kingston (CA); Lakshmi Varaha IYER, Troy, MI (US); Gerd SCHLAGER, Kefermarkt (AT); Michael NEUDORFHOFER, Sankt Valentin (AT); Wolfgang BAECK, Sankt Valentin (AT)

(21) Appl. No.: 17/425,574

(22) PCT Filed: Jan. 24, 2020
(86) PCT No.: PCT/US2020/014911

§ 371 Date: Jul. 23, 2021

Related U.S. Application Data
(60) Provisional application No. 62/796,536, filed on Jan. 24, 2019.
(60) Provisional application No. 62/796,547, filed on Jan. 24, 2019.

(51) Int. Cl. H02M 3/335; H02M 1/44; H02M 1/08; B60L 53/20

(52) U.S. Cl. CPC H02M 3/33592; H02M 3/33573; B60L 2210/10; H02M 1/08; B60L 53/20; H02M 1/44

(57) ABSTRACT

An LLC power converter comprises a switching stage and a resonant tank, the switching stage configured to switch an input power at a switching frequency to apply a switched power to the resonant tank, and the resonant tank includes a resonant inductor, a resonant capacitor, and a parallel inductance. A transformer has a primary winding connected to the resonant tank and a secondary winding. A synchronous rectifier (SR) switch is configured to selectively switch current from the secondary winding to supply a rectified current to a load. An RC filter includes a filter capacitor and a filter resistor connected across the SR switch, with the filter capacitor defining a filter capacitor voltage thereacross. A rectifier driver is configured to drive the SR switch to a conductive state in response to the filter capacitor voltage being less than a threshold value.

### CROSS REFERENCE TO RELATED APPLICATIONS

This PCT International Patent Application claims the benefit of U.S. Provisional Patent Application No. 62/796,536, filed Jan. 24, 2019, and U.S. Provisional Patent Application No. 62/796,547, filed Jan. 24, 2019, the contents of which are incorporated herein by reference in their entirety.

### FIELD

The present disclosure relates generally to inductor-inductor-capacitor (LLC) type power converters, and more specifically to control of synchronous rectifiers in a LLC power converter.

### BACKGROUND

Switching power supplies are commonly used to achieve high efficiency and high power-density. Resonant dc-dc converters are a popular type of switching power supply. A type of resonant converter, the LLC DC-DC converter is used widely in power supply applications. This circuit benefits from simplicity, low cost, high efficiency and soft-switching. Such LLC DC-DC converters include a rectifier to convert alternating current (AC) power to direct current (DC). Such rectifiers may include one or more rectifier diodes and/or one or more switches, such as switching transistors, also called synchronous rectifiers (SRs), to convert the AC power to DC. Due to the forward voltage drop of rectifier diodes, there is significant loss on rectifier diodes in some applications, particularly those with a low output voltage and high load current. Therefore, SRs are typically utilized for high load current LLC dc-dc converters to reduce the secondary losses.

Field effect transistors (FETs), such as metal-oxide-semiconductor field-effect transistor (MOSFET) devices are commonly used as switches in SR applications. One design feature of MOSFET devices is that their construction defines a body diode that functions to allow current flow in one direction and to block current flow in an opposite direction. In high load current applications, the loss of body diodes of SRs is much higher than conduction loss of SRs, thus the optimal efficiency of the converter depends on the well adjustment of SRs gate driving signals. Generally, when the voltage across SRs are detected to reach to a forward drop voltage (V_{F}) for several nanosecond continuously, SRs are turned on; and when the voltage across SRs are detected to reach to zero, SRs are turned off. However, real-world SR devices also have a parasitic inductance that is modeled as an inductor in series with SRs, and the parasitic inductance can lead to SR turn-off too early.

Compensator circuits have been proposed to address the issue of premature SR turn-on, some of which use digital detecting methods to turn on SRs by detecting turn-on of the body diodes of SRs. However, there still may be ringing voltage across SRs at high load current when the current flowing through SRs decreases to zero. When minimum of ringing voltage reaches close to zero, the body diodes of SRs become turned on. This causes early turn-on of the SRs and results in undesired and inefficient operation.

### SUMMARY

The present disclosure provides an LLC power converter comprising a switching stage and a resonant tank, the switching stage configured to switch an input power at a switching frequency to apply a switched power to the resonant tank, and the resonant tank including a resonant inductor, a resonant capacitor, and a parallel inductance. The LLC power converter also comprises a transformer having a primary winding connected to the resonant tank and a secondary winding. A synchronous rectifier (SR) switch is configured to selectively switch current from the secondary winding to supply a rectified current to a load. The LLC power converter also comprises a filter including a filter capacitor and a filter resistor connected across the SR switch, with the filter capacitor defining a filter capacitor voltage thereacross. A rectifier driver is configured to drive the SR switch to a conductive state in response to the filter capacitor voltage being less than a threshold value.

The present disclosure also provides a method of operating an LLC power converter. The method comprises sensing a filter capacitor voltage across a filter capacitor of a resistor-capacitor (RC) filter connected across a synchronous rectifier (SR) switch of the LLC power converter; comparing the filter capacitor voltage with a threshold voltage; and driving the SR switch to a conductive state in response to the filter capacitor voltage being less than the threshold voltage.

### BRIEF DESCRIPTION OF THE DRAWINGS

Further details, features and advantages of designs of the invention result from the following description of embodiment examples in reference to the associated drawings.

FIG. 1 is a schematic block diagram of a power distribution system of a motor vehicle;

FIG. 2 is a schematic diagram of a multi-phase LLC power converter in accordance with some embodiments of the present disclosure;

FIG. 3 is a schematic diagram of a single-phase LLC power converter in accordance with some embodiments of the present disclosure;

FIG. 4 shows graphs with lines of voltages and currents in an LLC power converter over a common time scale in accordance with some embodiments of the present disclosure;

FIG. 5A is a schematic diagram of a circuit equivalent to the single-phase LLC power converter shown in FIG. 3;

FIG. 5B is a schematic diagram of a circuit equivalent to the single-phase LLC power converter shown in FIG. 5A during a voltage ringing time;

FIG. 5C is a schematic diagram of a circuit equivalent to the single-phase LLC power converter shown in FIG. 5B;

FIG. 6 is a schematic diagram of to the single-phase LLC power converter shown in FIG. 5C with an equivalent RC filter;

FIG. 7 is a schematic diagram of a circuit equivalent to the single-phase LLC power converter shown in FIG. 3 with RC filters and drivers coupled to each of SR1 and SR2;

FIG. 8A is a graph showing lines of various parameters of a single-phase LLC power converter in accordance with some embodiments of the present disclosure;

FIG. 8B is a graph showing lines of various parameters of a single-phase LLC power converter in accordance with some embodiments of the present disclosure;

FIG. 9 is a graph showing lines of efficiency of a single-phase LLC power converter with different input voltages in accordance with some embodiments of the present disclosure;

FIG. 10 is a graph showing lines of efficiency vs. output current of a multi-phase LLC power converter in accordance with some embodiments of the present disclosure; and

FIG. 11 shows a flow chart of steps in a method of operating an LLC power converter in accordance with some embodiments of the present disclosure.

### DETAILED DESCRIPTION

Referring to the drawings, the present invention will be described in detail in view of following embodiments. In this disclosure, the ringing voltage across SRs is analyzed, and a zero-crossing filter for LLC dc-dc converter is proposed. By using the filter, LLC dc-dc converter can work well and keep high efficiency at high load current.

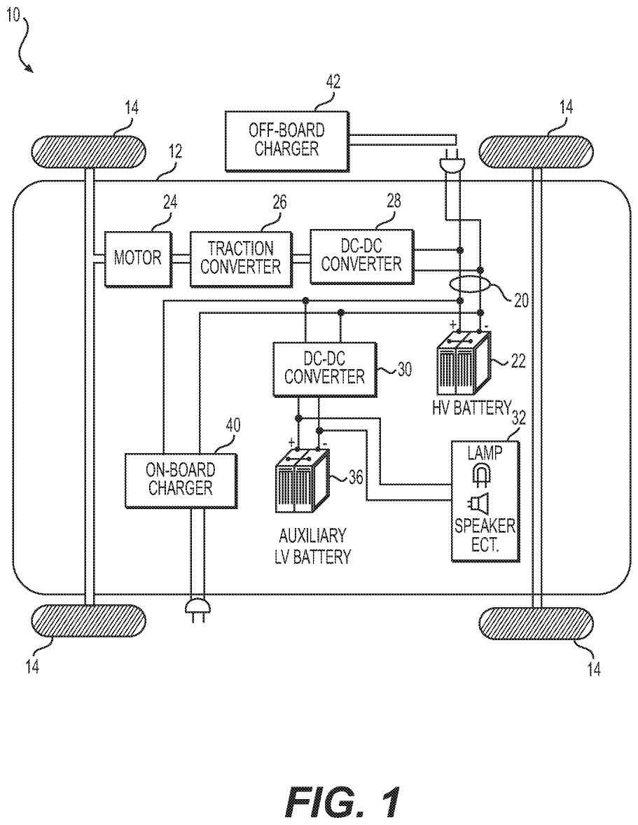

FIG. 1 is a schematic diagram showing a power distribution system 10 of a motor vehicle 12 having a plurality of wheels 14. The power distribution system 10 includes a high-voltage (HV) bus 20 connected to a HV battery 22 for supplying power to a motor 24, which is configured to drive one or more of the wheels 14. The HV bus 20 may have a nominal voltage that is 250 VDC-430 VDC, although other voltages may be used. The motor 24 is supplied with power via a traction converter 26, such as a variable-frequency alternating current (AC) drive, and a high-voltage DC-DC converter 28. The high-voltage DC-DC converter 28 supplies the traction converter 26 with filtered and/or regulated DC power having a voltage that may be greater than, less than, or equal to the DC voltage of the HV bus 20. A low-voltage DC-DC converter (LDC) 30 is connected to the HV bus 20 and is configured to supply low-voltage (LV) power to one or more LV loads 32 via a LV bus 34. The LDC 30 may be rated for 1-3 kW, although the power rating may be higher or lower. The LV loads 32 may include, for example, lighting devices, audio devices, etc. The LDC 30 may be configured to supply the low-voltage loads 32 with DC power having a voltage of, for example, 9-16 VDC, although other voltages may be used. An auxiliary LV battery 36 is connected to the LV bus 34. The auxiliary LV battery 36 may be a lead-acid battery, such as those used in conventional vehicle power systems. The auxiliary LV battery 36 may supply the LV loads 32 with power when the LDC 30 is unavailable. Alternatively or additionally, the auxiliary LV battery 36 may provide supplemental power to the LV loads 32 in excess of the output of the LDC 30. For example, the auxiliary LV battery 36 may supply a large inrush current to a starter motor that exceeds the output of the LDC 30. The auxiliary LV battery 36 may stabilize and/or regulate the voltage on the LV bus 34. An onboard charger 40 and/or an off-board charger 42 supply HV power to the HV bus 20 for charging the HV battery 22.

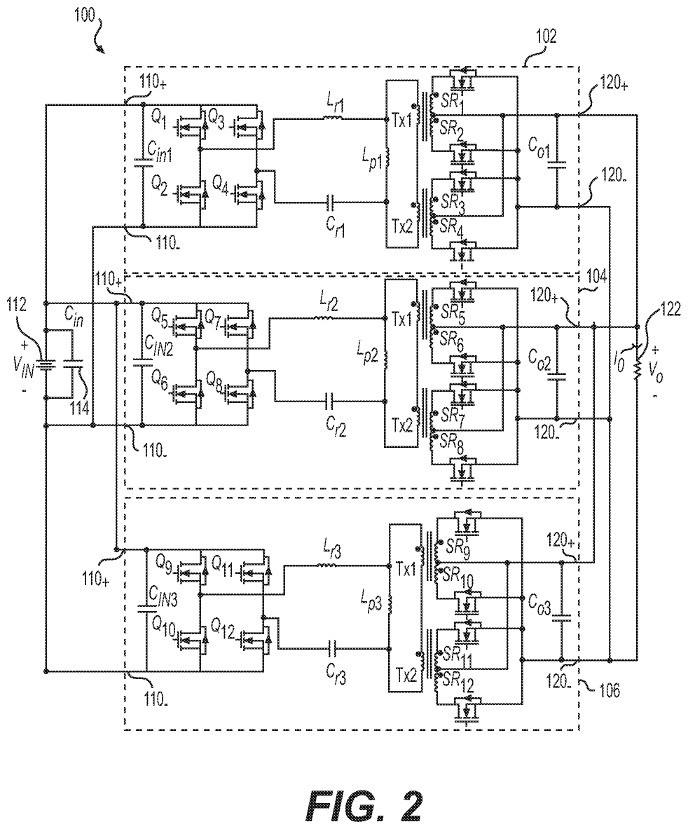

FIG. 2 is a schematic diagram of a multi-phase LLC power converter 100 in accordance with some embodiments of the present disclosure. The multi-phase LLC power converter 100 shown in FIG. 2 includes three single-phase LLC power converters 102, 104, 106, also called LLC phases, each connected in parallel with one another, and which share a common design. The multi-phase LLC power converter 100 may have a different number of single-phase LLC phases 102, 104, 106, and the number of LLC phases 102, 104, 106 may depend on design requirements of the multi-phase LLC power converter 100. Each of the single-phase LLC phases 102, 104, 106 defines an input bus 110+, 110− for receiving an input power having a DC voltage. The input busses 110+, 110− of each of the LLC phases 102, 104, 106 are connected in parallel with one another and to a DC voltage supply 112, such as a battery, having an input voltage Vᵢₙ. An input capacitor 114, such as a noise filter, having a capacitance Cᵢₙ is connected in parallel with the DC voltage supply 112. Each of the LLC phases 102, 104, 106 defines an output bus 120+, 120− having a positive terminal 120+ and a negative terminal 120− for conducting an output power having a DC output voltage Vo to a load 122. The output busses 120+, 120− of each of the LLC phases 102, 104, 106 are connected in parallel with one another and to the load 122.

In some embodiments, the multi-phase LLC power converter 100 may be used as a low-voltage DC-DC converter (LDC) configured to supply an output voltage of 9.0 to 16.0 VDC from an input having a voltage of 250-430 VDC. In some embodiments, the multi-phase LLC power converter 100 may have a peak efficiency of at least 96.7%. In some embodiments, the multi-phase LLC power converter 100 may have a full-load efficiency of at least 96.2%. In some embodiments, the multi-phase LLC power converter 100 may have a power density of at least about 3 kW/L.

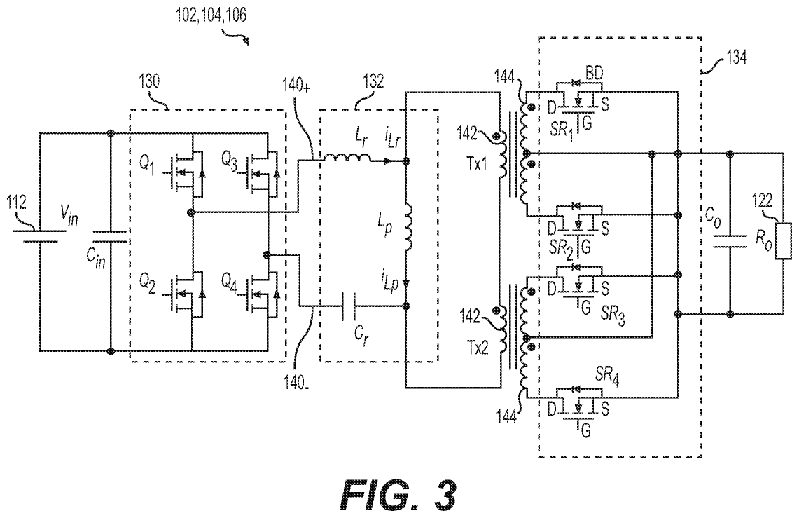

FIG. 3 is a schematic diagram of an example LLC phase 102, 104, 106 in accordance with some embodiments of the present disclosure. The example first LLC phase 102, 104, 106 shown in FIG. 3 may have a construction similar or identical to any one of the LLC phases 102, 104, 106 of the multi-phase LLC power converter 100, which may be identical to one another, with the exception of differences resulting from manufacturing tolerances.

The example LLC phase 102, 104, 106 shown in FIG. 3 includes a switching stage 130, a resonant tank 132, a set of transformers Tx1, Tx2, and a rectification stage 134. The switching stage 130 includes four high-speed switches Q1, Q2, Q3, Q4, with each of the high-speed switches being a Gallium Nitride (GaN) high-electron-mobility transistor (HEMT) configured to switch the input power to generate a switched power upon a switched power bus 140+, 140−, the switched power having an approximately sinusoidal (i.e. AC) waveform defining a switching frequency f_{sw}, which may also be called an AC frequency or an AC switching frequency. In some embodiments, the switching frequency exceeds 300 kHz. In some embodiments, the switching frequency f_{sw} may be varied between 260 and 400 kHz. In some other embodiments, the switching frequency f_{sw} may be varied between 260 and 380 kHz. In some embodiments, the high-speed switches Q1, Q2, Q3, Q4, may be switched at an operating frequency range of between 260 and 380 kHz.

Each of the four high-speed switches Q1, Q2, Q3, Q4 is configured to switch current from a corresponding one of a positive conductor 110+ or a negative conductor 110− of the input bus 110+, 110− to a corresponding one of a positive conductor 140+ or a negative conductor 140− of the switched power bus 140+, 140−. The switching stage 130 may have a different arrangement which may include fewer than or greater than the four high-speed switches Q1, Q2, Q3, Q4, shown in the example LLC phase 102 shown in FIG. 3. Each of the LLC phases 102, 104, 106 within the multi-phase LLC power converter 100 may have an equal switching frequency, and the AC waveforms of each of the LLC phases 102, 104, 106 may be in phase with one another. Alternatively, the AC waveforms of each of the LLC phases 102, 104, 106 may be out of phase from one another for interleaving the phases and producing a smoother output power than if the LLC phases 102, 104, 106 had AC waveforms that were in phase with one another.

The resonant tank 132 includes a resonant inductor Lr, a resonant capacitor Cr, and a parallel inductance Lp all connected in series with one another between the switched power bus 140+, 140−. The transformers Tx1, Tx2 each include a primary winding 142, with the primary windings 142 of the transformers Tx1, Tx2 connected in series with one-another, and with the series combination of the primary windings 142 connected in parallel with the parallel inductance Lp. The parallel inductance Lp may include a stand-alone inductor device. Alternatively or additionally, the parallel inductance Lp may include inductance effects, such as a magnetizing inductance, of the primary windings 142 of the transformers Tx1, Tx2. Each of the transformers Tx1, Tx2 has a secondary winding 144 with a center tap connected directly to the positive terminal 120+ of the output bus 120+, 120−. The ends of the secondary windings 144 of the transformers Tx1, Tx2 are each connected to the negative terminal 120− of the output bus 120+, 120− via a rectifier SR1, SR2, SR3, SR4 in the rectification stage 134. One or more of the rectifiers SR1, SR2, SR3, SR4 may take the form of a switch, such as a field effect transistor (FET), operated as a synchronous rectifier, as shown in FIG. 3. Alternatively or additionally, one or more of the rectifiers may be formed from one or more different types of switches, such as junction transistors, SCRs, etc. Each of the LLC phases 102, 104, 106 may include a different number of transformers Tx1, Tx2, which may be fewer than or greater than the two transformers Tx1, Tx2 shown in the example design depicted in the FIGs.

### Analysis of the Voltage Across SRs

For high load current applications, the conduction loss of the rectifiers SR1, SR2, SR3, SR4 is proportional to the square of load current in synchronous rectification LLC dc-dc converter. Therefore, two transformers Tx1, Tx2 with series-connected input (primary) windings 142 and parallel-connected output (secondary) windings 144 are adopted to reduce current stress of the rectifiers SR1, SR2, SR3, SR4, which is shown in FIG. 3 Because the primary windings 142 of the two transformers Tx1, Tx2 are in series, the current flowing through the primary windings 142 are the same, and the load current is divided by the two transformers Tx1, Tx2 and synchronous rectifiers SR1, SR2, SR3, SR4.

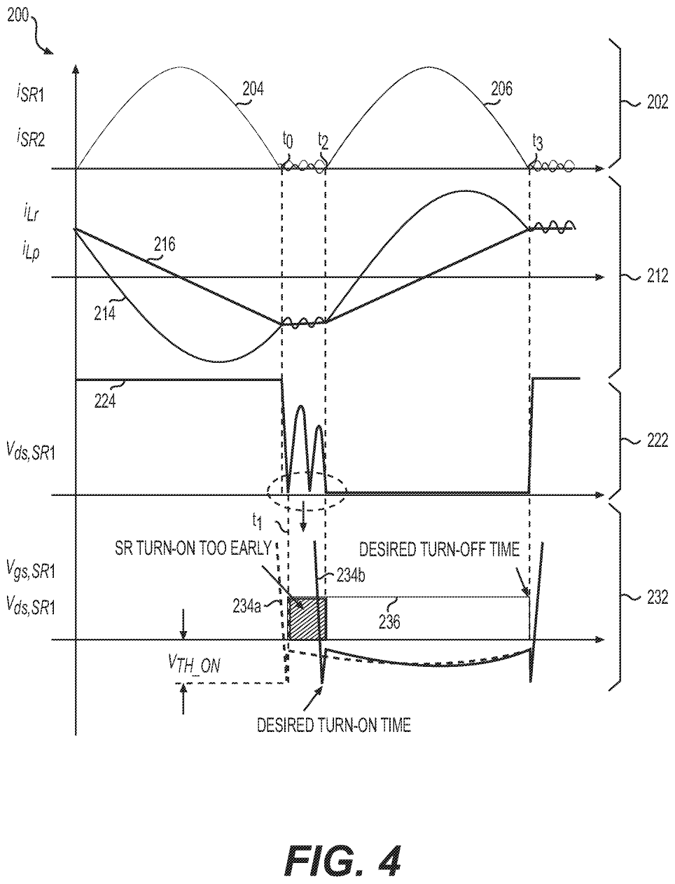

FIG. 4 shows a graph 200 with plots 202, 212, 222, and 232 of voltages and currents in an LLC power converter over a common time scale in accordance with some embodiments of the present disclosure. Specifically, FIG. 4 includes a first plot 202 with line 204 of current i_{SR1} through the first synchronous rectifier SR1 and line 206 of current i_{SR2} through the second synchronous rectifiers SR2. FIG. 4 also includes a second plot 212 with line 214 of the series resonant current i_{Lr} through the resonant inductor Lr and line 216 of parallel resonant current i_{Lp} through the parallel inductance Lₚ. FIG. 4 also includes a third plot 222 with line 224 of drain-source voltage V_{ds,SR1} across the first synchronous rectifier SR1. FIG. 4 also includes a fourth plot 232 showing an enlarged portion of the third plot 222. The fourth plot 232 includes line 234a showing an enlarged portion of line 224, when the drain-source voltage V_{ds,SR1} first reaches on-threshold voltage V_{TH_ON} at time t1, and line 234b showing an enlarged portion of line 224 when the drain-source voltage V_{ds,SR1} reaches on-threshold voltage V_{TH_ON} at time t2 after the ringing is over. The fourth plot 232 also includes line 236 of gate-source V_{gs,SR1}, which functions as the control signal to the first synchronous rectifier SR1, indicating a premature turn-on of the first synchronous rectifier SR1 at time t1, and the desired turn-on of the first synchronous rectifier SR1 at time t2, as well as the desired turn-off of the first synchronous rectifier SR1 at time t3.

As shown in FIG. 4, at high load current, there is severe voltage ringing across SRs between times t0 and t2, when the series resonant current i_{Lr} is approximately equal to parallel resonant current i_{Lp}. In SR LLC dc-dc converters, the turn-on time is usually detected by the drain-source voltage vas of the corresponding one of the SR switches SR₁, SR₂, SR₃, SR₄, and thus the voltage ringing can cause the SR switches SR₁, SR₂, SR₃, SR₄ to turn-on at time t0, which can cause abnormal and/or inefficient operation.

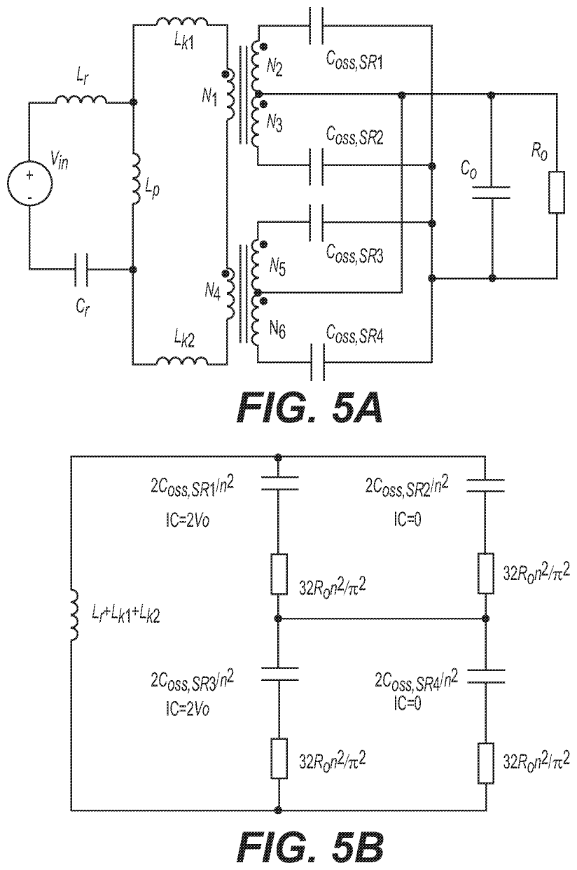

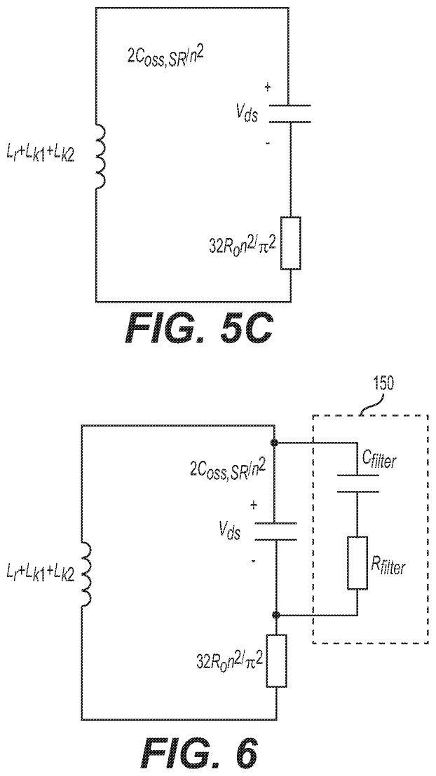

FIG. 5A shows an equivalent circuit of the LLC power converter of FIG. 4 during the voltage ringing, when high-speed switches Q1, Q2, Q3, Q4 are conducting, and the SR switches SR₁, SR₂, SR₃, SR₄ are turned off. The parasitic capacitance Cₒₛₛ of the SR switches SR₁, SR₂, SR₃, SR₄ is in series with the load and with the corresponding transformer secondary winding. Because Cᵣ>>Cₒₛₛ, and I_{Lr}=I_{Lp}, the equivalent circuit in FIG. 5A can be simplified to the circuit shown in FIG. 5B, and the impedance is transferred into the transformer primary. At an initial condition (IC), SR switches SR₁ and SR₃ are OFF, thus, the voltage across SR1 and SR3 are each 2Vo, and SR switches SR₂ and SR₄ are ON, the voltage across these two switches are each 0. If the parasitic capacitors of SRs C_{oss, SR} are each the same, the resonant frequency of the RLC circuit is:

$${f}_{r} = \frac{1}{2 π \sqrt{( {L}_{r} + {L}_{k 1} + {L}_{k 2} ) \frac{{C}_{oss , SR}}{{n}^{2}}}} . \qquad ( 1 )$$

The equivalent circuit in FIG. 5B can be further simplified to the circuit shown in FIG. 5C. As shown in FIG. 5C, the simplified equivalent circuit can be regarded as a second-order network. If the voltage across capacitor u_{c} (i.e. V_{ds}) is selected as state variables, equation (2) can be written according to Kirchhoff s Voltage Law (KVL). Characteristic equation is described in equation (3), which can be obtained as equation (4). Thus, the voltage across capacitor u_{c} is described in equation (5).

$$\begin{matrix}LC \frac{{d}^{2} {u}_{C}}{{dt}^{2}} + RC \frac{{du}_{C}}{dt} + {u}_{C} = 0. & ( 2 ) \\ {LCp}^{2} + RCp + 1 = 0. & ( 3 ) \\ {p}_{1 , 2} = - \frac{R}{2 L} \pm \sqrt{{( \frac{R}{2 L} )}^{2} - \frac{1}{LC}} . & ( 4 ) \\ {u}_{C} ( t ) = {K}_{1} {e}^{{p}_{1} t} + {K}_{2} {e}^{{p}_{2} t} . & ( 5 )\end{matrix}$$

The initial value of the voltage across capacitor u_{c} and the current flowing through inductor i_{L} are given in equations (6). Substituting (6) into (5) gives equation (7). And thus u_{c} is given by equation (8). Setting parameters in accordance with equation (9) provides equations (10).

$${u}_{C} ( {0}_{+} ) = {u}_{C} ( {0}_{-} ) = 2 {V}_{o}$$

$$\begin{matrix}{i}_{L} ( {0}_{+} ) = {i}_{L} ( {0}_{-} ) = 0. & ( 6 ) \\ \{ \begin{matrix}{K}_{1} + {K}_{2} = 2 {V}_{o} \\ {K}_{1} {p}_{1} + {K}_{2} {p}_{2} = 0\end{matrix} , {K}_{1} = \frac{2 {p}_{2} {V}_{o}}{{p}_{2} - {p}_{1}} and {K}_{2} = - \frac{{p}_{1}}{{p}_{2} - {p}_{1}} . & ( 7 ) \\ {u}_{C} ( t ) = \frac{2 {V}_{o}}{{p}_{2} - {p}_{1}} ( {p}_{2} {e}^{{p}_{1} t} - {p}_{1} {e}^{{p}_{2} t} ) . & ( 8 ) \\ α = \frac{R}{2 L} , {ω}_{0} = \sqrt{\frac{1}{LC}} , ω = \sqrt{\frac{1}{LC} - {( \frac{R}{2 L} )}^{2}} = \sqrt{{ω}_{0}^{2} - {α}^{2}} . & ( 9 ) \\ {p}_{1 , 2} = - α \pm j ω = - {ω}_{0} ∠ \pm φ and φ = arctan \frac{ω}{α} . & ( 10 )\end{matrix}$$

Substituting equations (9) and (10) into (8) gives equation (11).

$${u}_{C} ( t ) = \frac{2 {V}_{o} {ω}_{0}}{ω} {e}^{- α t} sin ( ω t + φ ) = \frac{2 {V}_{o}}{\sqrt{\frac{1}{LC} - {( \frac{R}{2 L} )}^{2}}} \sqrt{\frac{1}{LC}} sin ( \sqrt{\frac{1}{LC} - {( \frac{R}{2 L} )}^{2}} t + arctan \frac{2 L \sqrt{\frac{1}{LC} - {( \frac{R}{2 L} )}^{2}}}{R} ) . \qquad ( 11 )$$

If

$$ζ = \frac{R}{2} \sqrt{\frac{C}{L}} < 1 ,$$

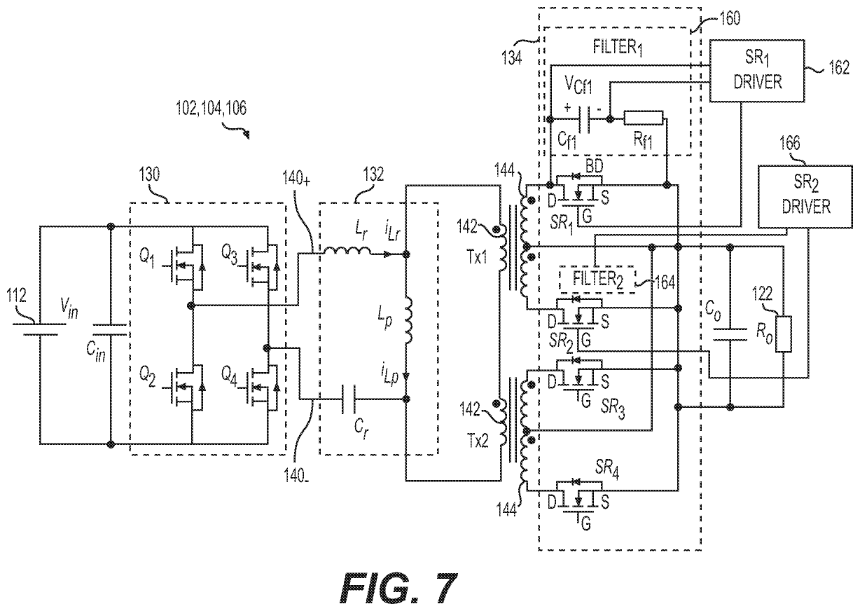

the circuit operates at underdamped, thus there is voltage ringing across the SRs. And according to equation (11), when the voltage across capacitor u_{c} is lower than zero, the SRs are turned on early. In order to address this issue, an RC equivalent 150 is connected in parallel with the parasitic capacitance of the SRs 2C_{oss,SR}/n², as shown in FIG. 6. The RC equivalent 150 may have a resistance of 510Ω and a capacitance value of 100 pF, although different values may be used for either or both of the resistance and/or the capacitance. In practice, the RC equivalent 150 takes the form of an RC filter 160, 164 connected in parallel with one or more of the SR switches SR₁, SR₂, SR₃, SR₄, as shown in FIG. 7.

FIG. 7 shows a schematic diagram of a circuit equivalent to the single-phase LLC power converter shown in FIG. 3, with the addition of an RC filter 160, 164, and a rectifier driver 162, 166 coupled to each of SR1 and SR2. Each of the RC filters 160, 164 includes a filter resistor R_{f1}, R_{f2} in series with a filter capacitor C_{f1}, C_{f2}, with each of the RC filters 160, 164 connected in parallel across a corresponding one of the SR switches SR1, SR2. The filter resistors R_{f1}, R_{f2} each have a resistance of 510Ω and the filter capacitors C_{f1}, C_{f2} each have a capacitance of 100 pF, although different values may be used for either or both of the resistance and/or the capacitance. Each of the filter capacitors C_{f1}, C_{f2} defines a corresponding filter capacitor voltage V_{cf1}, V_{cf2}, which is monitored by a corresponding rectifier driver 162, 166 and which is compared against a threshold value to control the corresponding SR switch SR₁ and SR₂. In other words, each of the rectifier drivers 162, 166 are configured to to drive the corresponding SR switch SR1, SR2 to a conductive state in response to the filter capacitor voltage V_{cf1}, V_{cf2}, being less than a threshold voltage V_{TH_ON}. The threshold voltage V_{TH_ON} may be 0.0V, although other higher or lower voltages may be used as the threshold voltage V_{TH_ON}.

To avoid bias current from the SR driver circuit 162, 166 offsetting the filter capacitor voltage V_{cf1}, V_{cf2}, the value of filter resistors R_{f1}, R_{f2} should be less than 1 kΩ. Besides, the RC time constant should be around 100 ns. Each of the SR switches SR₁, SR₂, SR₃, SR₄ may an RC filter 160, 164 connected thereacross, but FIG. 7 shows RC filters 160, 164 only on SR switches SR₁, SR₂ to simplify the disclosure. Each of the RC filters 160, 164 includes a filter capacitor C_{f1} in series with a filter resistor R_{f1}. The filter capacitor C_{f1} defines a voltage V_{Cf1} thereacross. The voltage V_{Cf1} across the filter capacitor C_{f1} may also be denoted u_{c}, or u_{c,filter} and is described in equation (12), below.

$${u}_{C , filter} ( t ) = {u}_{C} ( t ) \frac{\frac{1}{ω {C}_{filter}}}{\frac{1}{ω {C}_{filter}} + {R}_{filter}} ∠β and β = - arctan \frac{\frac{1}{ω {C}_{filter}}}{{R}_{filter}} . \qquad ( 12 )$$

It can be seen from equation (12), the amplitude of voltage across filter capacitor u_{c,filter} is divided by filter capacitor C_{filter} and filter resistor R_{filter}. If the voltage across the filter capacitor u_{c, filter} is detected to create turn-on signal for SRs, the minimum of detected voltage less than zero problem can be solved.

Specifications of a single-phase converter in accordance with the present disclosure are shown in Table. I.

TABLE I
SPECIFICATIONS OF ONE PHASE LLC CONVERTER

| | | | | | |
|---|---|---|---|---|---|
| Vᵢₙ | 250-430 | VDC | Lᵣ | 25 | μH |
| Vₒᵤₜ | 14 | VDC | Lₚ | 125 | μH |

| | | | | |
|---|---|---|---|---|
| Pₒᵤₜ/Iₒᵤₜ | 1300 W/90 A | Cₛ | 3.4 | nF |
| n | 44:1:1 | f_{sw} | 260-380 | KHz |

Table II presents a summary comparison of a proposed LDC in accordance with the present disclosure compared with eight different other reference DC-DC converter designs. As shown in Table. I, the proposed LDC achieves high efficiency and high power-density compared with other LDCs.

TABLE II
COMPARISON BETWEEN THE PROPOSED LDC AND OTHER REFERENCE DC-DC CONVERTERS

| | Specification of the Converter | | | | | | | |
|---|---|---|---|---|---|---|---|---|
| | Input | Output | | | Peak | Full-load | Power | Switching |
| Reference | voltage | voltage | Power | | efficiency | efficiency | density | frequency |
| [1] | 200 V~400 V | 12 V | 1.2 | kW | 95.5% | 90% | 0.5 kW/L | 100 kHz |
| [2] | 300 V | 12 V | 2 | kW | 94% | 93.2% | — | 227 kHz~297 kHz |
| [3] | 235 V~431 V | 11.5 V~15 V | 2 | kW | 93.5% | 93% | 0.94 kW/L | 200 kHz |
| [4] | 300 V~400 V | 12 V~16 V | 0.72 | kW | 93.5% | 90% | — | 100 kHz |
| [5] | 250 V~400 V | 13 V~15 V | 1 | kW | 93% | 92% | — | 100 kHz |
| [6] | 220 V~450 V | 6.5 V~16 V | 2.5 | kW | 93.2% | 92% | 1.17 kW/L | 90 kHz~200 kHz |
| [7] | 260 V~430 V | 12.5 V~14.5 V | 1.9 | kW | 93% | 91% | 1.02 kW/L | 65 kHz~150 kHz |
| [8] | 200 V~400 V | 12 V | 2 | kW | 95.9% | 94.2% | — | 100 kHz~133 kHz |
| The | 250 V~430 V | 9 V~16 V | 3 | kW | 96.7% | 96.2% | 3 kW/L | 260 kHz~400 kHz |
| proposed | | | | | | | | |
| LDC | | | | | | | | |

### Experimental Results

To verify the analysis, a 1.26 kW prototype is designed. The series resonant inductor is 25 μH, the parallel inductor is 125 μH, the resonant capacitor is 3.3 nF and transformer ratio is np:ns1:ns2=22:1:1. Input voltage range is 250V-430V and output voltage range is 9V-16V. 90 A load current at 14V output voltage is achieved, and SRs are turned on properly.

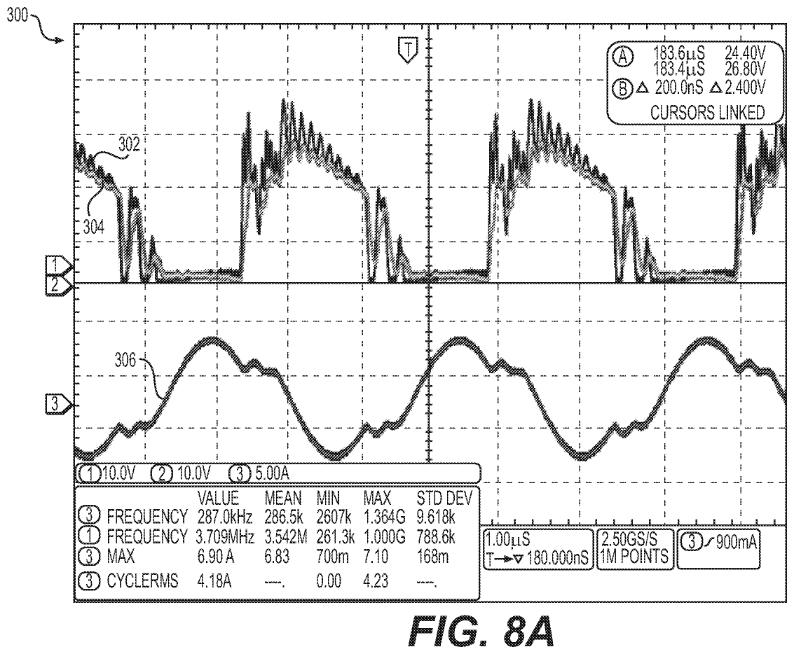

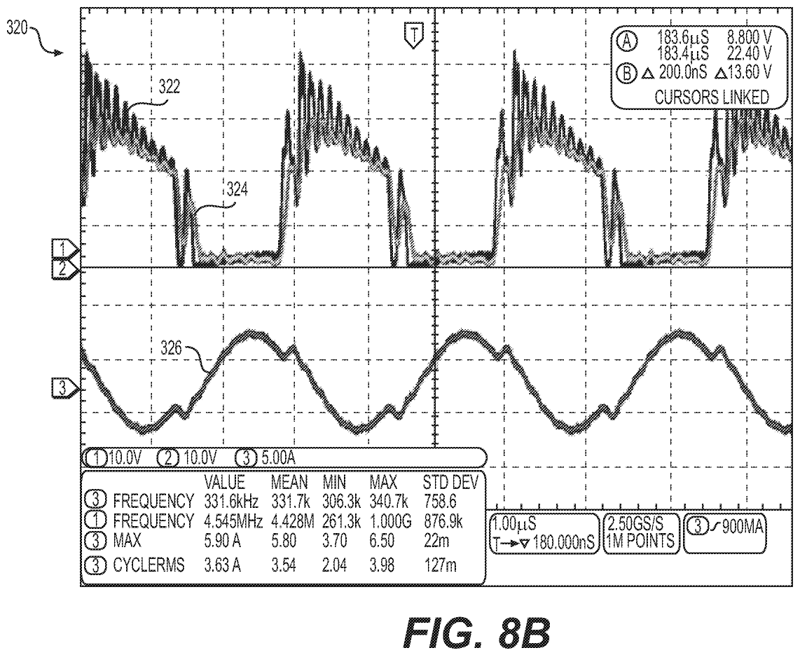

FIG. 8A is a graph 300 showing lines 302, 304, 306 of various parameters of a single-phase LLC power converter 102, 104, 106 over a common time scale with input voltage Vᵢₙ=250V, output voltage Vₒᵤₜ=14V, and output current Iₒ=60 A. Specifically, line 302 shows the drain-source voltage V_{ds} across the first SR switch SR₁, and line 304 shows the filter capacitor voltage V_{Cf1} of the filter capacitor C_{f1} of RC filter 160. FIG. 8B is a graph 320 showing lines 322, 324, 326 of various parameters of a single-phase LLC power converter 102, 104, 106 over a common time scale with input voltage Vᵢₙ=380V, output voltage Vₒᵤₜ=14V, and output current Iₒ=70 A. Specifically, line 322 shows the drain-source voltage V_{ds} across the first SR switch SR₁, and line 324 shows the filter capacitor voltage V_{Cf1} of the filter capacitor C_{f1} of RC filter 160.

As shown in FIGS. 8A-8B, the SRs would be turned on early if the voltage across the SR switches SR₁, SR₂, SR₃, SR₄ is selected as detected voltage. The filter capacitor voltage V_{Cf1} across the filter capacitor C_{f1} is selected instead and this problem is solved in the proposed circuit.

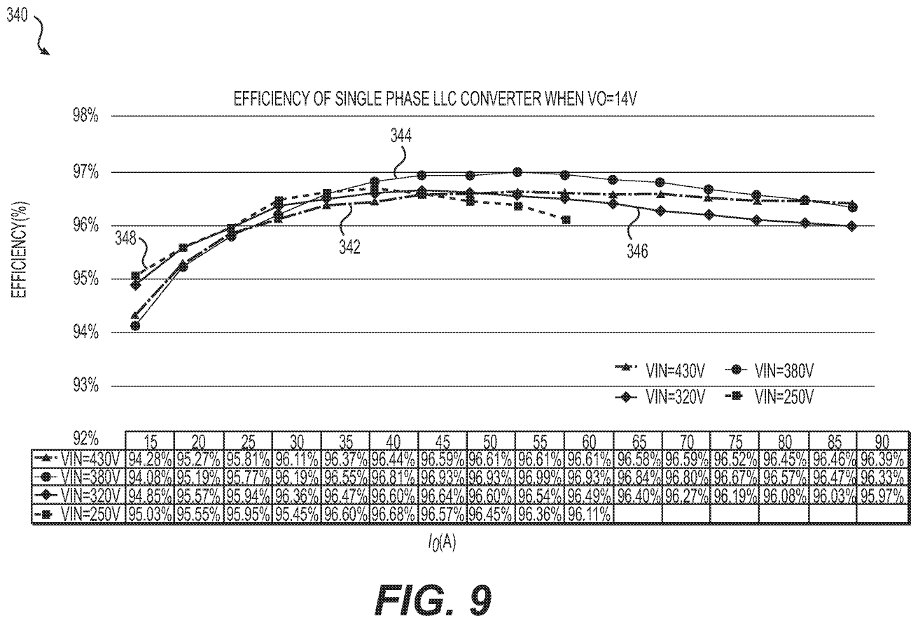

FIG. 9 is a graph 340 showing lines 342, 344, 346, 346 of measured efficiency of a single-phase LLC dc-dc converter with output voltage Vo=14V and with SRs operated in accordance with the present disclosure, using the voltage across the filter capacitor, u_{c,filter}. Specifically line 342 shows the converter operated with input voltage Vᵢₙ=430V; line 344 shows the converter operated with input voltage Vᵢₙ=380V; line 346 shows the converter operated with input voltage Vᵢₙ=320V; and line 348 shows the converter operated with input voltage Vᵢₙ=250V. Peak efficiency of 96.99% is realized at 55A load current when the input voltage Vᵢₙ is 380V and the output voltage is 14V.

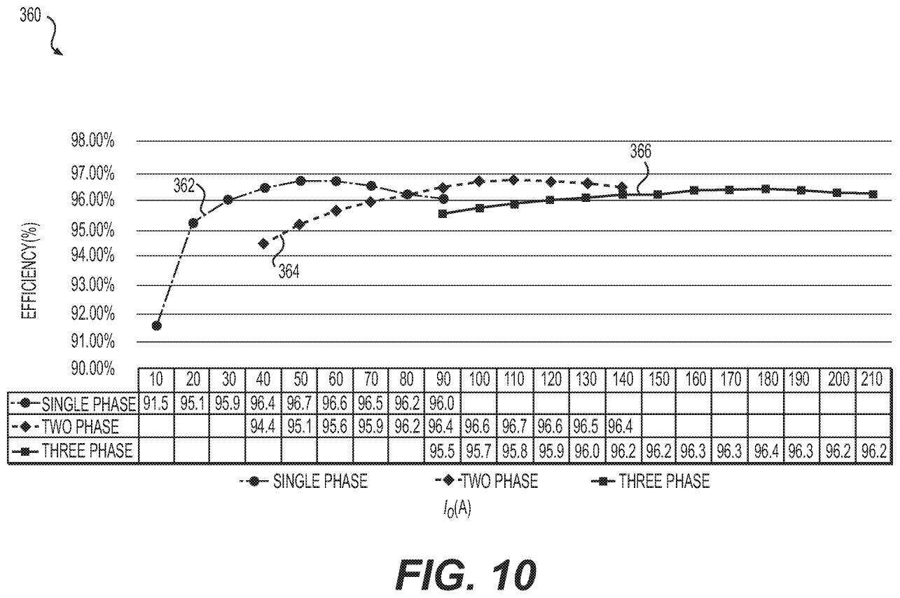

FIG. 10 is a graph 360 showing lines 362, 364, 366 of efficiency vs. output current of a multi-phase LLC power converter 100 in accordance with some embodiments of the present disclosure. Specifically, line 362 shows the multi-phase LLC power converter 100 operating in a single-phase mode, with only one of the LLC phases 102, 104, 106 operational. Line 364 shows the multi-phase LLC power converter 100 operating in a two-phase mode, with two of the LLC phases 102, 104, 106 operational. Line 366 shows the multi-phase LLC power converter 100 operating in a three-phase mode, with all three of the LLC phases 102, 104, 106 operational. FIG. 10 shows the efficiency of the proposed LDC. When the input voltage Vᵢₙ is 380V and output voltage is 14V, 96.2% efficiency is achieved at 210A load current. Peak efficiency is 96.7%. When load current is light, the proposed LDC can run only one phase LLC dc-dc converter to reduce switching loss; when load current is medium, the proposed LDC can run two phase LLC dc-dc converters; when load current is high, the proposed LDC can run three phase LLC dc-dc converters to reduce conduction loss. As shown in FIG. 10, from 10A to 80A, 80A to 150A and 150A to 210A, one phase circuit, two phase circuit and three phase circuit are adopted. Thus, high efficiency can be achieved in all load ranges.

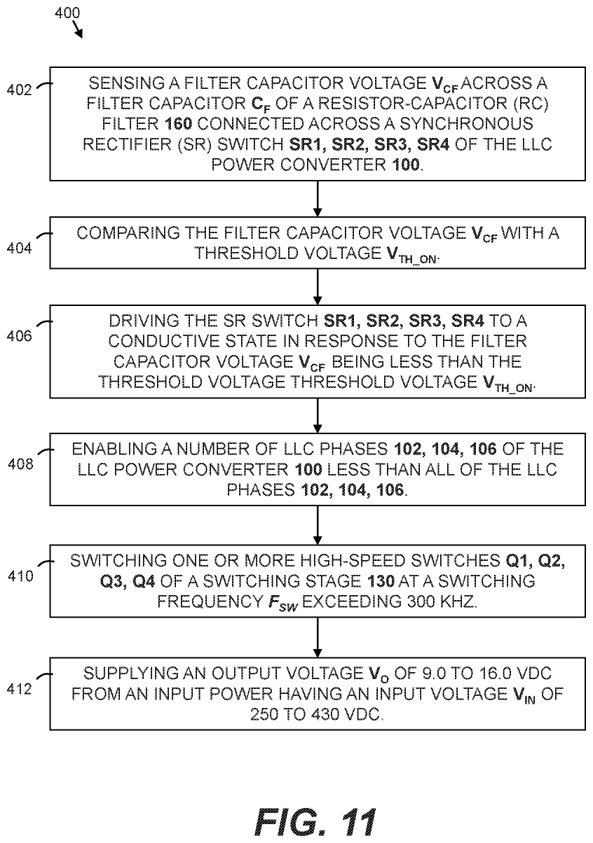

A method 400 of operating an LLC power converter 100 is shown in the flow chart of FIG. 11. Actual operation may include additional steps beyond those listed here. The method 400 includes sensing a filter capacitor voltage V_{Cf} across a filter capacitor C_{f} of a resistor-capacitor (RC) filter 160 connected across a synchronous rectifier (SR) switch SR1, SR2, SR3, SR4 of the LLC power converter 100 at step 402.

The method 400 also includes comparing the filter capacitor voltage V_{Cf} with a threshold voltage V_{TH_ON} at step 404. Step 404 may be performed by a comparator, which may include hardware, software, or a combination of hardware and software. The threshold voltage threshold voltage V_{TH_ON} may be 0.0 V, although the threshold voltage V_{TH_ON} may be higher or lower than 0.0 V. The threshold voltage V_{TH_ON} may be fixed or variable.

The method 400 also includes driving the SR switch SR1, SR2, SR3, SR4 to a conductive state in response to the filter capacitor voltage V_{Cf} being less than the threshold voltage threshold voltage V_{TH_ON} at step 406. Driving the SR switch to the conductive state may include asserting or de-asserting a control signal coupled to a gate of the SR switch SR1, SR2, SR3, SR4.

Steps 402-406 may each be performed for each of two SR switches SR1, SR2, SR3, SR4 connected to a single secondary winding 144 of a transformer Tx1, Tx2. For example, as shown in FIG. 7, SR switches SR1, SR2 may each be connected to opposite ends of a center-tapped secondary winding 144. Furthermore, Steps 402-404 may each be performed for each of four or more different SR switches SR1, SR2, SR3, SR4 within the LLC power converter 100. For example, two SR switches SR1, SR2, SR3, SR4 may be connected to secondary windings 144 of each of two or more different transformers Tx1, Tx2.

The method 400 may also include enabling a number of LLC phases 102, 104, 106 of the LLC power converter 100 less than all of the LLC phases 102, 104, 106 at step 408. This may be called phase shedding. A controller may enable only as many of the LLC phases enabled 102, 104, 106 as are needed to satisfy an output current requirement of the multi-phase LLC power converter 100. Satisfying the output current requirement may include generating an output current that meets the demand of a load 122. Alternatively or additionally, satisfying the output current requirement may include operating the LLC power converter 100 with number of LLC phases 102, 104, 106 causing the LLC power converter 100 to operate with a highest efficiency. For example, and with reference to FIG. 10, the LLC power converter 100 can be operated with either of one or two LLC phases to produce an output current of 60 A, but one phase operation is more efficient for the output current of 60 A.

The method 400 may also include switching one or more high-speed switches Q1, Q2, Q3, Q4 of a switching stage 130 at a switching frequency f_{sw} exceeding 300 kHz at step 410 to apply a switched power to a resonant tank 132 of the LLC power converter 100. The high-speed switches Q1, Q2, Q3, Q4 may be Gallium Nitride (GaN) high-electron-mobility transistors (HEMTs). In some embodiments, the switching frequency f_{sw} may be varied between 260 and 400 kHz. In some other embodiments, the switching frequency f_{sw} may be varied between 260 and 380 kHz. In some embodiments, the high-speed switches Q1, Q2, Q3, Q4, may be switched at an operating frequency range of between 260 and 380 kHz.

The method 400 may also include supplying an output voltage Vₒ of 9.0 to 16.0 VDC from an input power having an input voltage Vᵢₙ of 250 to 430 VDC at step 412.

### CONCLUSIONS

This disclosure presents a zero-crossing filter for driving synchronous rectifiers of LLC DC-DC converters to reduce or eliminate the effect of voltage ringing across SRs in high load current applications. In the proposed LLC DC-DC converter, GaN HEMTs are used in the switching stage 130, thus switching frequency is greater than in conventional DC-DC converters, and the volume of the circuit is reduced. Zero voltage switching (ZVS) turn-on of the high-speed switches Q1, Q2, Q3, Q4 and secondary SRs is achieved, zero current switching (ZCS) turn-off of secondary SRs is also realized. By detecting the voltage across the filter capacitor to create the turn-on signal for SRs, the problem of early SR turn-on is reduced or eliminated. In the proposed LLC DC-DC converter, wide input and output voltage ranges are realized. Peak efficiency of 96.99% at 55A load current is achieved.

The system, methods and/or processes described above, and steps thereof, may be realized in hardware, software or any combination of hardware and software suitable for a particular application. The hardware may include a general purpose computer and/or dedicated computing device or specific computing device or particular aspect or component of a specific computing device. The processes may be realized in one or more microprocessors, microcontrollers, embedded microcontrollers, programmable digital signal processors or other programmable device, along with internal and/or external memory. The processes may also, or alternatively, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a machine readable medium.

The computer executable code may be created using a structured programming language such as C, an object oriented programming language such as C++, or any other high-level or low-level programming language (including assembly languages, hardware description languages, and database programming languages and technologies) that may be stored, compiled or interpreted to run on one of the above devices as well as heterogeneous combinations of processors processor architectures, or combinations of different hardware and software, or any other machine capable of executing program instructions.

Thus, in one aspect, each method described above and combinations thereof may be embodied in computer executable code that, when executing on one or more computing devices performs the steps thereof. In another aspect, the methods may be embodied in systems that perform the steps thereof, and may be distributed across devices in a number of ways, or all of the functionality may be integrated into a dedicated, standalone device or other hardware. In another aspect, the means for performing the steps associated with the processes described above may include any of the hardware and/or software described above. All such permutations and combinations are intended to fall within the scope of the present disclosure.

The foregoing description is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

1. A method of operating an LLC power converter comprising:
sensing a filter capacitor voltage across a filter capacitor of a resistor-capacitor (RC) filter connected across a synchronous rectifier (SR) switch of the LLC power converter;
comparing the filter capacitor voltage with a threshold voltage; and
driving the SR switch to a conductive state in response to the filter capacitor voltage being less than the threshold voltage.

2. The method of claim 1, wherein the threshold voltage is 0.0 V.

3. The method of claim 1, wherein sensing the filter capacitor voltage, comparing the filter capacitor voltage with a threshold voltage, and driving the synchronous rectifier to the conductive state are each performed for each of two SR switches connected to a secondary winding of a transformer.

4. The method of claim 1, further comprising: enabling a number of LLC phases of the LLC power converter, with the number of LLC phases enabled being only as many as are needed to satisfy an output current of the multi-phase LLC power converter.

5. The method of claim 1, further comprising switching one or more high-speed switches of a switching stage at a switching frequency exceeding 300 kHz to apply a switched power to a resonant tank of the LLC power converter.

6. The method of claim 1, further comprising supplying an output voltage of 9.0 to 16.0 VDC from an input power of 250 to 430 VDC.

7. An LLC power converter comprising:
a switching stage and a resonant tank, the switching stage configured to switch an input power at a switching frequency to apply a switched power to the resonant tank, and the resonant tank including a resonant inductor, a resonant capacitor, and a parallel inductance;
a transformer having a primary winding connected to the resonant tank and a secondary winding;
a synchronous rectifier (SR) switch configured to selectively switch current from the secondary winding to supply a rectified current to a load;
a filter including a filter capacitor and a filter resistor connected across the SR switch, the filter capacitor defining a filter capacitor voltage thereacross; and
a rectifier driver configured to drive the SR switch to a conductive state in response to the filter capacitor voltage being less than a threshold value.

8. The power converter of claim 7, wherein the threshold voltage is 0.0 V.

9. The power converter of claim 7, wherein the SR switch is one of a two SR switches each connected to the secondary winding of the transformer, with each of the two SR switches having a filter connected thereacross; and
wherein the rectifier driver is one of two rectifier drivers each configured to drive a respective one of the SR switches to the conductive state in response to an associated filter capacitor voltage being less than the threshold value.

10. The power converter of claim 9, wherein the transformer is one of two transformers, with each of the two transformers having a primary winding connected in series with one another and connected to the resonant tank.

11. The power converter of claim 7, wherein the switching stage comprises one or more Gallium Nitride (GaN) high-electron-mobility transistors (HEMTs); and
wherein the switching frequency exceeds 300 kHz.

12. A low-voltage DC-DC converter (LDC) for an electrified vehicle comprising the power converter of claim 7 configured to supply an output voltage of 9.0 to 16.0 VDC from the input power having a voltage of 250 to 430 VDC.

13. The power converter of claim 7, wherein the power converter has a peak efficiency of at least 96.7%.

14. The power converter of claim 7, wherein the power converter has a full-load efficiency of at least 96.2%.

15. The power converter of claim 7, wherein the power converter has power density of at least about 3 kW/L.

16. The power converter of claim 7, wherein the RC filter includes a resistor in series with a capacitor, the resistor having a resistance less than 1 kΩ.

17. The power converter of claim 16, wherein the resistor has a resistance of 510Ω.

18. The power converter of claim 16, wherein the capacitor has a capacitance of 100 pf.

19. The method of claim 1, wherein the RC filter includes a resistor in series with a capacitor, the resistor having a resistance less than 1 kΩ.

20. The method of claim 19, wherein the capacitor has a capacitance of at least about 100 pf.
